(19) United States
(12) Patent Application Publication
(10) Pub. No.: US 2007/0286670 A1
(43) Pub. Date: Dec. 13, 2007

(54) RING BINDER MECHANISM

(76) Inventor: Kin Chung Wilson Wong, Kowloon (HK)

Correspondence Address: EVAN LAW GROUP LLC, 600 WEST JACKSON BLVD., SUITE 625, CHICAGO, IL, 60661, US

(21) Appl. No.: 11/750,518

(22) Filed: May 18, 2007

Related U.S. Application Data
(60) Provisional application No. 60/801,073, filed on May 18, 2006.

(51) Int. Cl. B42F 13/20

(52) U.S. Cl. 402/38

(57) ABSTRACT

A ring binder mechanism includes a housing, a hinge plate pivotally connected to the housing, a ring member attached to the hinge plate, and an actuator attached to the housing and operatively connected to a locking device. The locking device is rotatably connected to the housing and is configured to rotate between a first position and a second position.

The present application claims priority to U.S. Provisional Application Ser. No. 60/801,073, entitled “Ring Binder Mechanism,” which was filed on May 18, 2006, the content of which is incorporated herein by reference.

### BACKGROUND

A ring binder retains loose-leaf pages, such as hole-punched papers, in a file or notebook. It features ring members for retaining the papers, which may be selectively opened to add or remove papers, or closed to retain papers while allowing them to be moved along the ring members. A ring binder mechanism may be provided for moving the ring members between the open and closed position. However, there is a continual need to provide a ring binder mechanism with improved operability and convenience to the users.

### BRIEF SUMMARY

According to one aspect, a ring binder mechanism includes a housing, a hinge plate pivotally connected to the housing, a ring member attached to the hinge plate, and an actuator attached to the housing and operatively connected to a locking device. The locking device is rotatably connected to the housing and is configured to rotate between a first position and a second position.

According to another aspect, a method of unlocking a ring binder mechanism includes pushing down on an actuator, uncontacting a blocking member of a rotary member away from a pivotal axis of a hinge plate, rotating the blocking member into a receiving notch of the hinge plate, pivoting the hinge plate, and disengaging a ring member. The ring member is attached to the hinge plate. The hinge plate is pivotally connected to a housing. The actuator is attached to the housing and operatively connected to the rotary member.

According to a further aspect, a method of locking a ring binder mechanism includes pushing on a ring member, pivoting a hinge plate, rotating a blocking member of a rotary member away from a receiving notch of the hinge plate, contacting the blocking member with the hinge plate along a pivotal axis, and engaging the ring member. The ring member is attached to the hinge plate. The hinge plate is pivotally connected to a housing.

### BRIEF DESCRIPTION OF THE DRAWINGS

FIG. 1 depicts a perspective view of a ring binder mechanism as used in a binder.

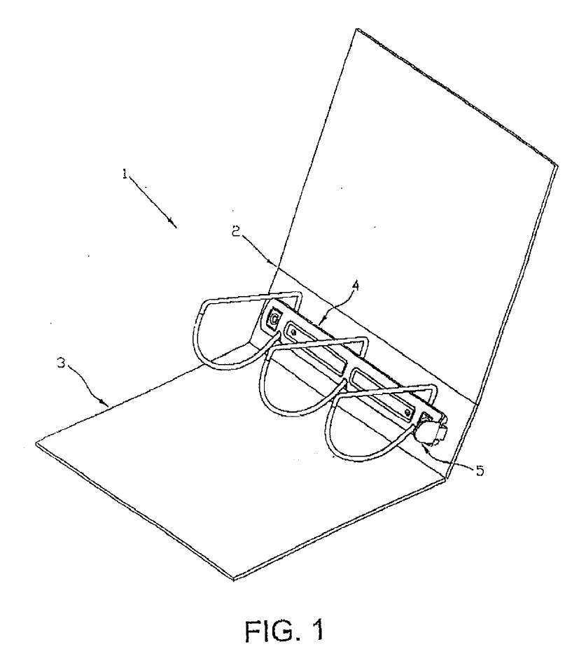

FIG. 2A depicts a front perspective view of the ring binder mechanism in a closed position.

FIG. 2B depicts a cross-section view of the ring binder mechanism along line 2B-2B of FIG. 2A.

FIG. 3A depicts a front perspective view of the ring binder mechanism in an open position.

FIG. 3B depicts a cross-section view of the ring binder mechanism along line 3B-3B of FIG. 3A.

FIG. 4 depicts a back perspective view of the ring binder mechanism in a closed position.

FIG. 5 depicts a back perspective view of the ring binder mechanism in an open position.

FIG. 6 depicts a front exposed perspective view of the ring binder mechanism in a closed position.

FIG. 7 depicts a front exposed perspective view of the ring binder mechanism in an open position.

FIG. 8 depicts a back-exploded perspective view of the locking device of the ring binder mechanism.

FIG. 9 depicts a front-exploded perspective view of the locking device of the ring binder mechanism in a closed position.

### DETAILED DESCRIPTION

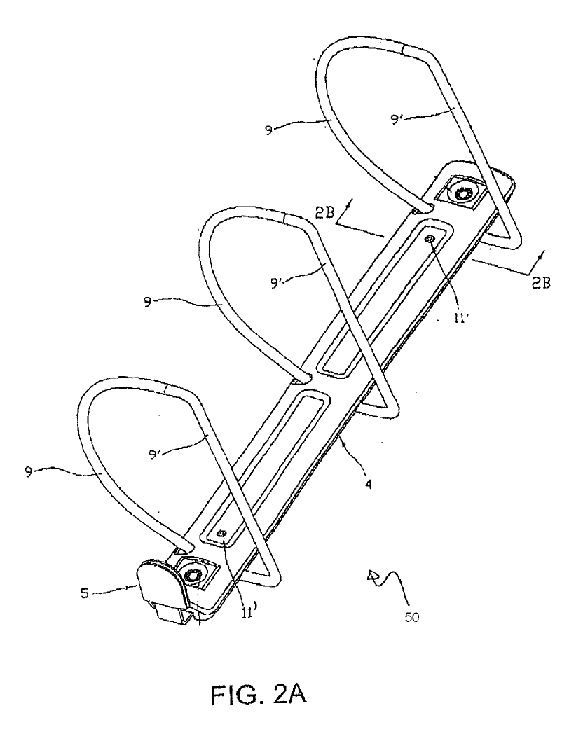

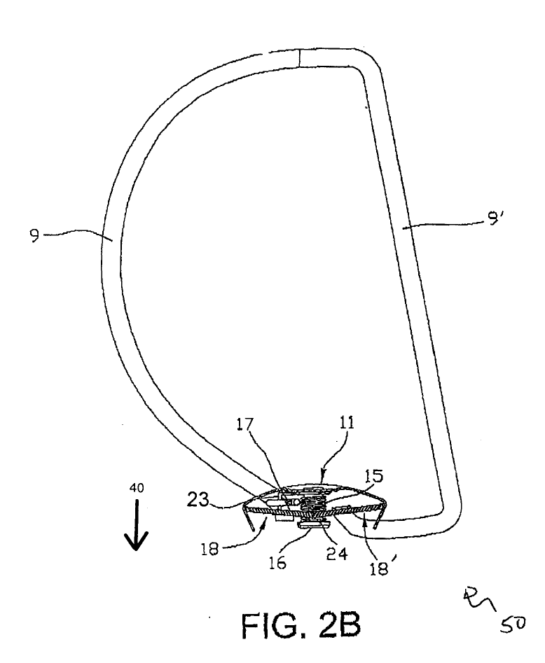

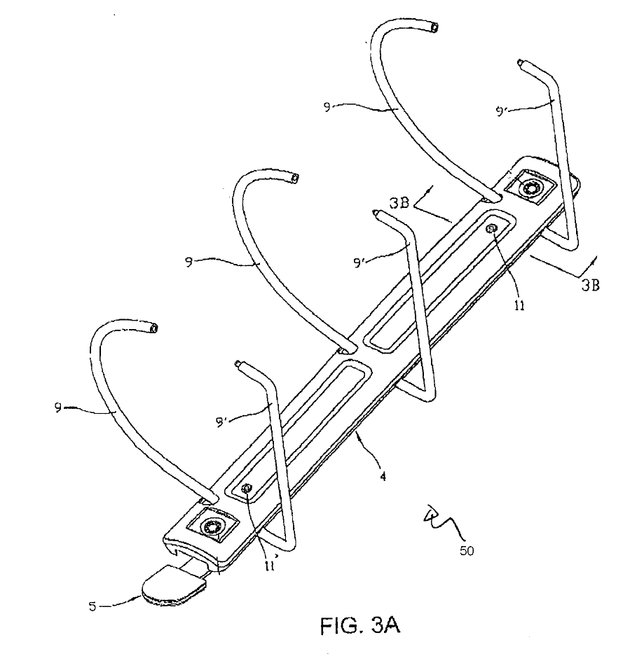

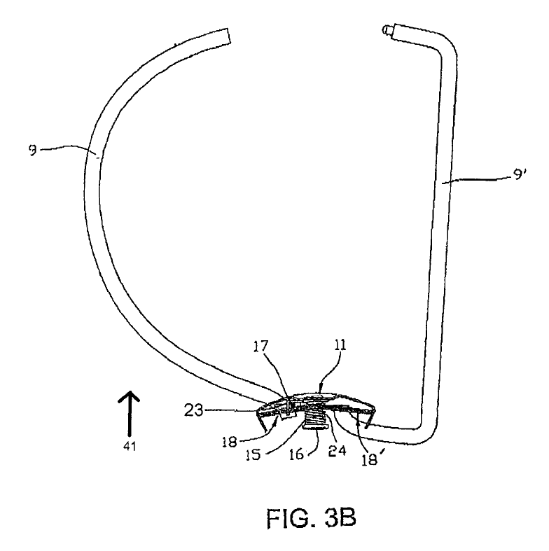

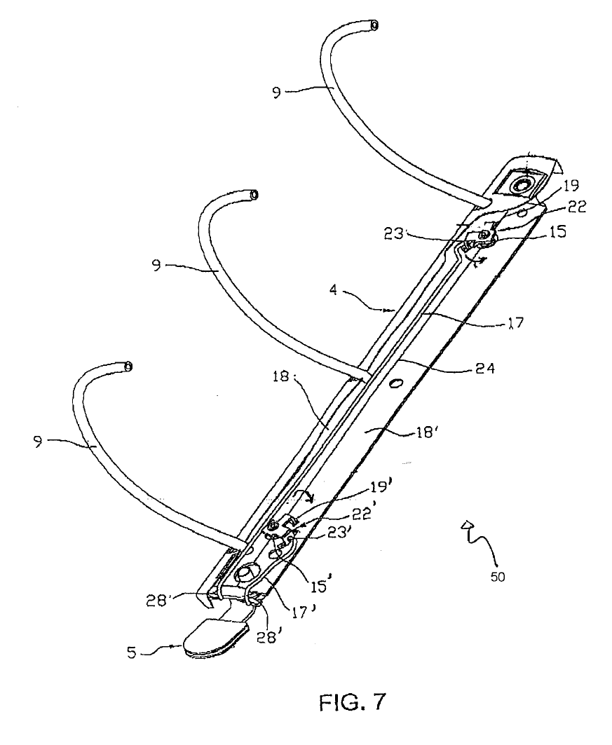

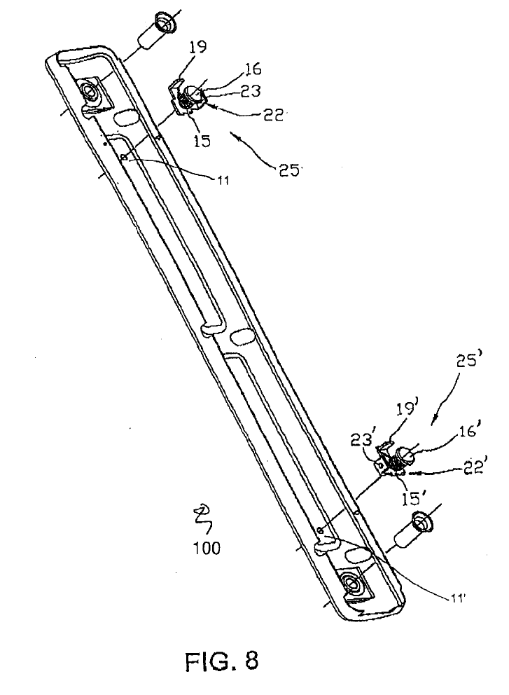

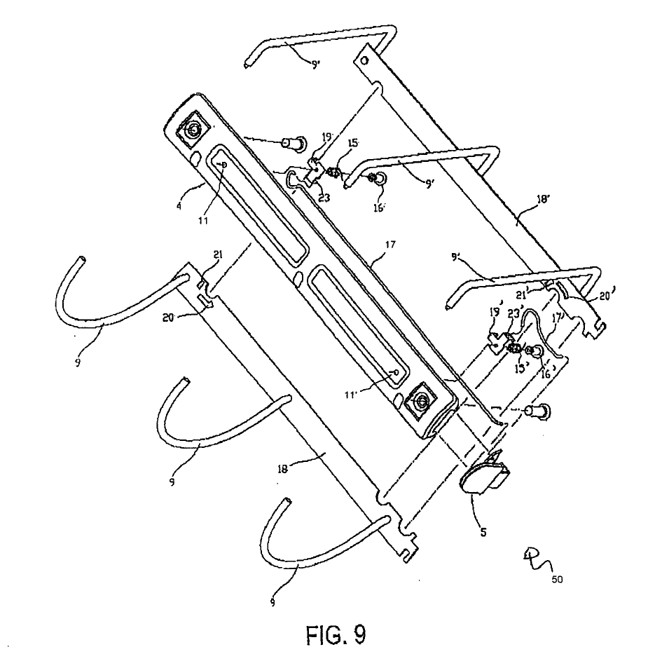

A ring binder mechanism 50 includes a housing 4, a hinge plate 18 housed in the housing 4, a ring member 9 attached to the hinge plate 18, a locking device 25 attached to the housing 4, and a connecting member 17 operatively connected to an actuator 5 at joint 28 and operatively connected to the locking device 25 at joint point 23, as depicted in FIGS. 7 and 9. The locking device 25 includes a rotary member 22, a spring 15 biased against the rotary member 22 and a mounting member 16 moveably fixing the rotary member 22 to the housing 4, as depicted in FIG. 8. In the closed position, the ring member 9 is enclosed, and papers or other printing materials may be held by the ring binder mechanism 50, as depicted in FIGS. 2A and 2B. In the open position, the ring member 9 is not enclosed, and papers or other printing materials may be added to or removed from the ring binder mechanism 50, as depicted in FIGS. 3A and 3B.

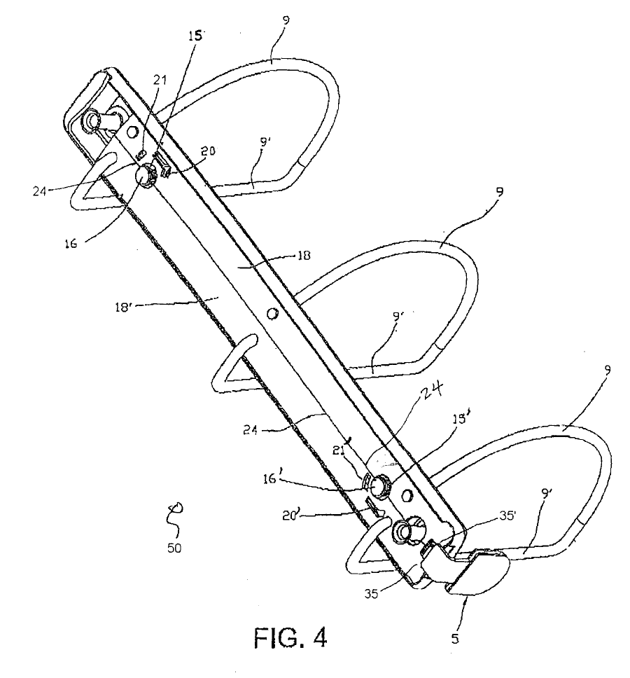

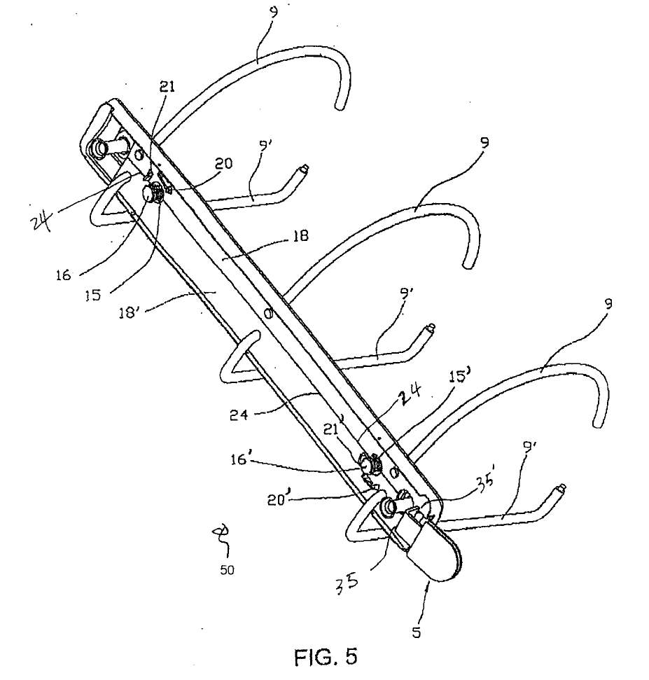

The housing 4 may be made of any casing materials commonly known to one skilled in the art and may be made of stainless steel or metal. The hinge plate 18 may be an elongated member that attaches to one or more ring members 9 and may be configured to pivot between an open and a closed position such that the ring member 9 may be operable for holding papers or other printing materials, as depicted in FIGS. 2B and 3B. The hinge plate 18 may include a receiving notch 21 configured to receive a blocking member 19 of the rotary member 22 and may also include a guide notch 20 configured to guide the guide member 23 of the rotary member 22, when the ring binder mechanism 50 goes from a closed position to an open position, as depicted in FIGS. 4 and 5.

The ring member 9 may be in the form of a ring or other enclosed structure capable of holding papers or other printing materials when closed, as depicted in FIGS. 2A and 2B, and may be capable of receiving and removing papers or other printing materials when open, as depicted in FIGS. 3A and 3B. For example, three ring members 9 may be attached to the hinge plate 18, although any other number may be used.

For example, the ring binder mechanism 50 may include two hinge plates 18 and 18′, where hinge plate 18 is connected to a ring member 9 and where hinge plate 18′ is connected to a ring member 9′, as depicted in FIGS. 2B and 3B. When the ring binder mechanism 50 is in an open position, ring member 9 may move along the direction of arrow 41 until ring member 9 comes into contact with ring member 9′, as depicted in FIG. 3B. In particular, pivoting the hinge plates 18 and 18′ allows the ring members 9 and 9′ to engage, and the ring binder mechanism 50 turns to a closed position, as depicted in FIG. 2B. In a closed position, the ring members 9 and 9′ are engaged and allow papers or other printing materials to be held by the ring binder mechanism 50.

When the ring binder mechanism 50 is in a closed position, ring member 9 may move along the direction of arrow 40 until ring member 9 goes out of contact with ring member 9′, as depicted in FIG. 2B. In particular, pivoting the hinge plates 18 and 18′ allows the ring members 9 and 9′ to disengage and space apart from each other, and the ring binder mechanism 50 turns to an open position as depicted in FIG. 3B. In an open position, the ring members 9 and 9′ are disengaged from each other and spaced apart, which allows papers or other printing materials to be inserted or removed from the ring binder mechanism 50.

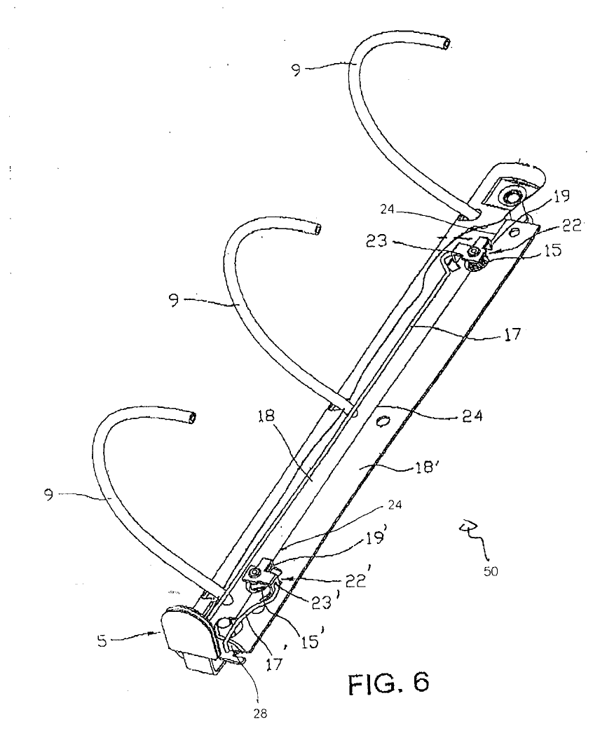

The locking device 25 includes a rotary member 22, a spring 15 biased against the rotary member 22 in a first position, and a mounting member 16 moveably fixing the rotary member 22 to the housing 4, as depicted in FIG. 8. The rotary member 22 includes a blocking member 19, which, when in contact with the hinge plates 18 and 18′ along a pivotal axis 24, prevents the hinge plates 18 and 18′ from pivoting, as depicted in FIGS. 4 and 6. Therefore, the rotary member 22 may be rotated between a locked position and an unlocked position. When the rotary member 22 is rotated to the locked position, the hinge plates 18 and 18′ may be prevented from pivoting, as depicted in FIGS. 4 and 6. On the other hand, when the rotary member 22 is rotated to the unlocked position, and the blocking member 19 is inserted into the receiving notch 21, the hinge plates 18 and 18′ may pivot along the pivotal axis 24, as depicted in FIGS. 5 and 7.

The spring 15 may be wrapped around the mounting member 16 and bias the rotary member 22 against a first position. For example, the first position is a locked position. The spring 15 is configured to allow the rotary member 22 to rotate to and bias against a second position. For example, the second position is an unlocked position. The spring 15 may be a torsion spring, although other springs known to one skilled in the art may also be used. The mounting member 16 may be used to moveably fix the rotary member 22 and spring 15 to an opening 11 of the housing 4, as depicted in FIG. 8. For example, a shaft may be used, although other mounting members that are known to one skilled in the art that can affix a rotary member and a spring to a housing while allow the rotary member to rotate about the mounting member may also be used.

The actuator 5 may include a lever, although other members, such as a booster, that are known to one skilled in the art to actuate the ring binder mechanism 50 between a closed position and an open position may also be used. The actuator 5 may be configured to move between an up position, which corresponds to the ring binder mechanism 50 being closed or locked, as depicted in FIGS. 2A and 4, and a down position, which corresponds to the ring binder mechanism 50 being open or unlocked, as depicted in FIGS. 3A and 5. The actuator 5 may be connected to the rotary member 22 of the locking device 25 through a connecting member 17, as depicted in FIGS. 6 and 7. The connecting member 17 may be a rigid body, a steel wire or combinations thereof. For example, the first end of the connecting member 17 may be attached to the guide member 23 of the rotary member 22, while the second end of the connecting member 17 may be attached to the actuator 5 at the joint 28.

In the closed position, the actuator 5 is in the up position, as depicted in FIGS. 2A and 4. The spring 15 of the locking device 25 biases the rotary member 22 against the locked position, where the blocking member 19 of the rotary member 22 is in contact with the hinge plates 18 and 18′ along the pivotal axis 24 and prevents the hinge plates 18 and 18′ from pivoting, as depicted in FIGS. 4 and 6. In this configuration, the ring members 9 and 9′ that are attached to the hinge plates 18 and 18′, respectively, are engaged to each other, as depicted in FIGS. 2A, 2B and 4. Therefore, the papers or other printing materials may be held by the ring members 9 and 9′.

To actuate the ring binder mechanism 50 from the closed position, as depicted in FIGS. 4 and 6, to the open position, as depicted in FIGS. 5 and 7, a user may push on the actuator 5. When the actuator 5 is pushed to the down position, the actuator 5, through the connecting member 17, pulls the guide member 23 and rotates the rotary member 22 from the locked position, as depicted in FIG. 6, to the unlocked position, as depicted in FIG. 7, and biases the spring 15. As the rotary member 22 rotates from the locked position to the unlocked position, the blocking member 19 of the rotary member 22 also rotates away from the pivotal axis 24 and into the receiving notch 21. This causes the blocking member 19 to get out of contact with the hinge plates 18 and 18′, and thus allows the hinge plates 18 and 18′ to pivot. As the actuator 5 is pushed further downward, the actuator 5 pushes on the hinge plates 18 and 18′ at the contact points 35 and 35′, as depicted in FIG. 5, and causes the hinge plates 18 and 18′ to pivot in the direction of arrow 41, as depicted in FIG. 3B, from the closed position to the open position. As the hinge plates 18 and 18′ are pivoted to the open position, the ring members 9 and 9′ that are connected to the hinge plates 18 and 18′, respectively, disengage and pivot away from each other.

In the open position, the actuator 5 is in the down position, as depicted in FIGS. 3A and 5. The rotary member 22 is at the unlocked position, with the blocking member 19 in the receiving notch 21, as depicted in FIGS. 5 and 7. The hinge plates 18 and 18′ are in the open position, and the ring members 9 and 9′ are disengaged and away from each other, as depicted in FIGS. 3A, 3B and 5. Therefore, the disengaged ring members 9 and 9′ allow papers or other printing materials to be added or removed.

To actuate the ring binder mechanism 50 from the open position, as depicted in FIGS. 5 and 7, to the closed position, as depicted in FIGS. 4 and 6, a user may push one or more of the ring members 9 and 9′ toward each other. As the ring members 9 and 9′ are pushed toward each other, the hinge plates 18 and 18′ that are connected to ring members 9 and 9′, respectively, also pivot in the direction of arrow 40, as depicted in FIG. 2B, from the open position to the closed position. As the hinge plates 18 and 18′ are pivoting, the blocking member 19 of the rotary member 22 is removed from the receiving notch 21 and moves toward the pivotal axis 24. The spring 15 that biases the rotary member 22 against the closed position rotates the rotary member 22 from the unlocked position, as depicted in FIG. 5, to the locked position, as depicted in FIG. 4. As the rotary member 22 rotates to the locked position, the guide member 23 of rotary member 22, through the connecting member 17, pulls the actuator 5 to the up position. In the closed position, the ring binder mechanism 50 is in the same configuration as the closed position described previously.

In another embodiment, the ring binder mechanism 100 may include two locking devices 25 and 25′, as depicted in FIG. 8. The locking device 25′ is similar to the locking device 25 described above and operates in tandem with locking device 25. Specifically, the locking device 25′ includes a rotary member 22′, a spring 15′ biased against the rotary member 22′ in a first position, and a mounting member 16′ moveably fixing the rotary member 22′ to the housing 4. The rotary member 22′ includes a guide member 23′ through which the connecting member 17′ is attached to the actuator 5 at the contact point 28′, and a blocking member 19′, which when engaged with the hinge plates 18 and 18′ along a pivotal axis 24 prevents the hinge plates 18 and 18′ from pivoting, as depicted in FIG. 6. The hinge plate 18′ may also include a guide notch 20′ configured to guide the guide member 23′ of the rotary member 22′, when the ring binder mechanism 100 goes from a closed position to an open position, as depicted in FIGS. 4 and 5.

The rotary member 22′ may be rotated between a locked position and an unlocked position. When the rotary member 22′ is rotated to the locked position, the hinge plates 18 and 18′ may be prevented from pivoting, as depicted in FIGS. 4 and 6. On the other hand, when the blocking member 19′ of the rotary member 22′ is rotated to the unlocked position and into a receiving notch 21′, the hinge plates 18 and 18′ may pivot away from the pivotal axis 24, as depicted in FIGS. 5 and 7.

The spring 15′ may be wrapped around the mounting member 16′ and bias the rotary member 22′ against a first position. For example, the first position is a locked position. The spring 15′ is configured to allow the rotary member 22′ to rotate to and bias against a second position. For example, the second position is an unlocked position. The spring 15′ may be a torsion spring, although other springs known to one skilled in the art may also be used. The mounting member 16′ may be used to moveably fix the rotary member 22′ and spring 15′ to an opening 11′ of the housing 4, as depicted in FIG. 8. For example, a shaft may be used, although other mounting members that are known to one skilled in the art that can affix the rotary member and spring to the housing while allowing the rotary member to rotate about the mounting member may also be used.

A ring binder 1 includes the ring binder mechanism 50 or 100 and a cover flat 3 attached to the ring binder mechanism 50 or 100.

It should be understood that the ring binder mechanism is not limited to the precise embodiments described below, and that various changes and modifications thereof may be effected by one skilled in the art without departing from the spirit or scope of the invention. For example, elements and/or features of different illustrative embodiments may be combined with each other and/or substituted for each other within the scope of this disclosure and appended claims.

What is claimed is:

1. A ring binder mechanism, comprising:
a housing;
a hinge plate pivotally connected to said housing;
a ring member attached to said hinge plate; and
an actuator attached to said housing and operatively connected to a locking device,
wherein said locking device is rotatably connected to said housing and is configured to rotate between a first position and a second position.

2. The ring binder mechanism of claim 1, wherein said locking device comprises a rotary member.

3. The ring binder mechanism of claim 2, wherein said rotary member comprises a blocking member.

4. The ring binder mechanism of claim 3, wherein said hinge plate comprises a receiving notch for receiving said blocking member.

5. The ring binder mechanism of claim 2, wherein said rotary member comprises a guide member.

6. The ring binder mechanism of claim 5, wherein said hinge plate comprises a guide notch for guiding said guide member.

7. The ring binder mechanism of claim 2, wherein said locking device further comprises a spring biased against said rotary member to said first position.

8. The ring binder mechanism of claim 7, wherein said spring comprises a torsion spring.

9. The ring binder mechanism of claim 2, wherein said locking device further comprises a mounting member moveably fixing the rotary member to said housing.

10. The ring binder mechanism of claim 9, wherein said mounting member comprises a shaft.

11. The ring binder mechanism of claim 1, further comprising a connecting member connecting said actuator to said locking device.

12. The ring binder mechanism of claim 11, wherein said connecting member is a wire.

13. The ring binder mechanism of claim 11, wherein said actuator is a lever.

14. The ring binder mechanism of claim 1, wherein said first position is a closed position.

15. The ring binder mechanism of claim 14, wherein said ring member is enclosed at said closed position.

16. The ring binder mechanism of claim 1, wherein said second position is an open position.

17. The ring binder mechanism of claim 16, wherein said ring member is not enclosed at said open position.

18. A ring binder, comprising:
the ring binder mechanism of claim 1; and
a cover layer attached to said ring binder mechanism.

19. A method of unlocking a ring binder mechanism, comprising:
pushing down on an actuator;
uncontacting a blocking member of a rotary member away from a pivotal axis of a hinge plate;
rotating said blocking member into a receiving notch of said hinge plate;
pivoting said hinge plate; and
disengaging a ring member,
wherein said hinge plate is attached to said ring member, wherein said hinge plate is pivotally connected to a housing, and wherein said actuator is attached to said housing and operatively connected to said rotary member.

20. A method of locking a ring binder mechanism, comprising:
pushing on a ring member;
pivoting a hinge plate;
rotating a blocking member of a rotary member away from a receiving notch of said hinge plate;
contacting said blocking member with said hinge plate along a pivotal axis; and
engaging said ring member,
wherein said hinge plate is attached to said ring member, wherein said hinge plate is pivotally connected to a housing.
